(19) United States
(12) Patent Application Publication
(10) Pub. No.: US 2014/0125072 A1
(43) Pub. Date: May 8, 2014

(54) DOOR HANDLE FOR VEHICLE

(71) Applicant: AISIN SEIKI KABUSHIKI KAISHA, Kariya-shi, Aichi (JP)

(72) Inventors: Koichi Nagata, Chiryu-shi (JP); Nobukazu Araki, Hekinan-shi (JP); Naoya Asano, Ichinomiya-shi (JP)

(73) Assignee: AISIN SEIKI KABUSHIKI KAISHA, Kariya-shi, Aichi (JP)

(21) Appl. No.: 14/128,364

(22) PCT Filed: Jun. 4, 2012
(86) PCT No.: PCT/JP2012/064372

§ 371 Date: Dec. 20, 2013

(30) Foreign Application Priority Data
Jun. 22, 2011 (JP) 2011-138479

(51) Int. Cl. E05B 1/00

(52) U.S. Cl. CPC E05B 1/00
USPC 292/336.3

(57) ABSTRACT

A door handle for a vehicle is provided with a handle body and a handle cover. The handle body has on one end side thereof an engagement protrusion and a first arm, and on the other end side thereof a pin through-hole and a second arm. The handle cover has on one end side there of an engagement recess to which the engagement protrusion is connected so that the engagement protrusion can tilt, and the handle cover also has on the other end side thereof a connection pin inserted through the pin through-hole and penetrating through the pin through-hole. A decoration is provided to at least outer surface of the handle cover. The connection pin is welded and affixed to the pin through-hole.

### TECHNICAL FIELD

The present invention relates to a door handle for a vehicle for opening or closing the door of the vehicle, which door handle is mounted outside the door.

### BACKGROUND ART

As a door handle for a vehicle of this type, there has been known one disclosed in Patent Literature 1. This door handle is configured to be mounted outside a door of the vehicle in a state where a handle body (described as a housing member in Patent Literature 1) made by resin and a handle cover (described as a covering member in Patent Literature) made by resin are in a state united integrally.

### CITATION LIST

### Patent Literature

[PTL 1] JP 4543722 B

### SUMMARY OF INVENTION

### Technical Problems

In Patent Literature 1 described above, a front arm and a rear arm are formed to a housing member (the outer member disposed on the outer side in a state of being mounted outside the door), and a decoration (e.g., painting or plating) is provided to the outer surface of the housing member. Therefore, when a decoration is provided to the outer surface of the housing member, such painting or the plating, and the like might adhere to the front arm and the rear arm not requiring a decoration, and it is necessary to mask so that such painting or the plating, and the like may not adhere to the front arm and the rear arm. And, in Patent Literature 1 described above, it is necessary to use a fastener member (the parts being difference from the housing member and the covering member) such as screws and welding nuts in order to unify the housing member and the covering member (the inner member disposed on the inner side in a state of being mounted outside the door) integrally.

### Solution to Problems The present invention has been made to solve the above-mentioned problems, and therefore there is provided a door handle for a vehicle, including:

a door handle for a vehicle, comprising: a handle body made by resin, which has on one end side thereof an engagement protrusion and a first arm (e.g., rear arm), and on the other end side thereof a pin through-hole and a second arm (e.g., a front arm),

a handle cover made by resin, which has on one end side thereof an engagement recess to which the engagement protrusion is connected so that the engagement protrusion can tilt, and has on the other end side thereof a connection pin inserted through the pin through-hole and penetrating through the pin through-hole, and a decoration (e.g., painting or plating) is provided to at least outer surface of the handle cover, and the handle cover is united to the outside of the handle body integrally and covers outside the handle body by the connection pin being welded and affixed to the pin through-hole in conditions that the engagement protrusion is connected to the engagement recess and the connection pin is inserted through the pin through-hole,

wherein the handle body and the handle cover are mounted integrally outside the door of the vehicle.

In this case, it is possible that the pin through-hole is oval configuration to assume the long distance direction of the door handle for a vehicle a longer axis, or is a long aperture shape to extend along a longitudinal direction of the door handle for a vehicle. Further, it is possible that the handle body is provided with a guide (for example, a lib formed integrally with the handle body, or electronic parts assembled to the handle body) which can guide the connection pin of the handle cover through the pin through-hole of the handle body when the handle body is joined to the handle cover. Further, it is possible that a locking part for stopping a tool for decoration (for example, a tool used when decoration such as painting or plating is provided outside of the handle cover) is formed integrally inside of the handle cover.

### Advantageous Effects of Invention

According to the door handle for a vehicle of the described above present invention, the handle body comprises the first arm and the second arm, and it is not had to provide each arm to the handle cover in which the decoration (e.g., painting or plating) is made on the outer surface. Therefore, when a decoration such as painting or plating is provided, for example, to the outer surface of the handle cover, it is not necessary to mask an unnecessary part of the decoration to prevent for attaching that painting or plating to the unnecessary part uselessly.

Further, according to the present invention, the handle cover is united to the outside of the handle body integrally and covers outside the handle body by the connection pin being welded and affixed to the pin through-hole in conditions (the state that the handle body and the handle cover are combined and joined each other) that the engagement protrusion provided to the handle body is connected to the engagement recess provided to the handle cover and the connection pin is inserted through the pin through-hole. Therefore, the fasteners (parts which are different from the handle body and the handle cover) such as screws and welding nuts are unnecessary to join the handle cover to the handle body integrally.

Further, on the occasion of enforcement of the present invention, in the case that the pin through-hole has an even oval configuration to assume a longitudinal direction of the door handle for a vehicle a longer axis, or is formed in a long aperture shape extending along a longitudinal direction of the door handle for a vehicle, it can make the pin through-hole engage the connection pin smoothly when the handle body and the handle cover are combined and joined each other. Further, it can smoothly perform joining work for joining the handle body to the handle cover in the case that the handle body is provided with the guide which can guide the connection pin of the handle cover through the pin through-hole of the handle body when joining the handle cover to the handle body. Further, in the case that locking parts to stop a tool for decoration is formed integrally inside of the handle cover, it can easily perform work for providing a decoration to at least the outer surface of the handle cover.

### BRIEF DESCRIPTION OF DRAWINGS

FIG. 1 is a front view illustrating an embodiment of a door handle for a vehicle according to the present invention.

FIG. 2 is a right side view illustrating the door handle for a vehicle shown in FIG. 1.

FIG. 3 is a bottom view illustrating the door handle for a vehicle shown in FIG. 1.

FIG. 4 is a sectional end view along the line A-A of FIG. 3.

FIG. 5 is a sectional end view along the line B-B of FIG. 3.

FIG. 6 is a sectional enlarged end view along the line C-C of FIG. 3.

FIG. 7 is a sectional enlarged end view along the line D-D of FIG. 3.

FIG. 8 is a sectional enlarged end view along the line E-E of FIG. 3.

FIG. 9 is a sectional enlarged end view along the line F-F of FIG. 3.

FIG. 10 is a sectional enlarged end view along the line G-G of FIG. 3.

FIG. 11 is a sectional enlarged end view along the line H-H of FIG. 1.

FIG. 12 is an outside perspective view of a handle body of shown in FIGS. 1 to 11.

FIG. 13 is an inside perspective view of the handle body of shown in FIGS. 1 to 11.

FIG. 14 is an outside perspective view of a handle cover of shown in FIGS. 1 to 11.

FIG. 15 is an inside perspective view of the handle cover of shown in FIGS. 1 to 11.

FIG. 16 is an outside perspective view of a modification of the handle body.

FIG. 17 is a schematic perspective view of an attached state, for illustrating the door handle for a vehicle according to the present invention, which door handle is mounted outside the door of a vehicle.

### DESCRIPTION OF EMBODIMENTS

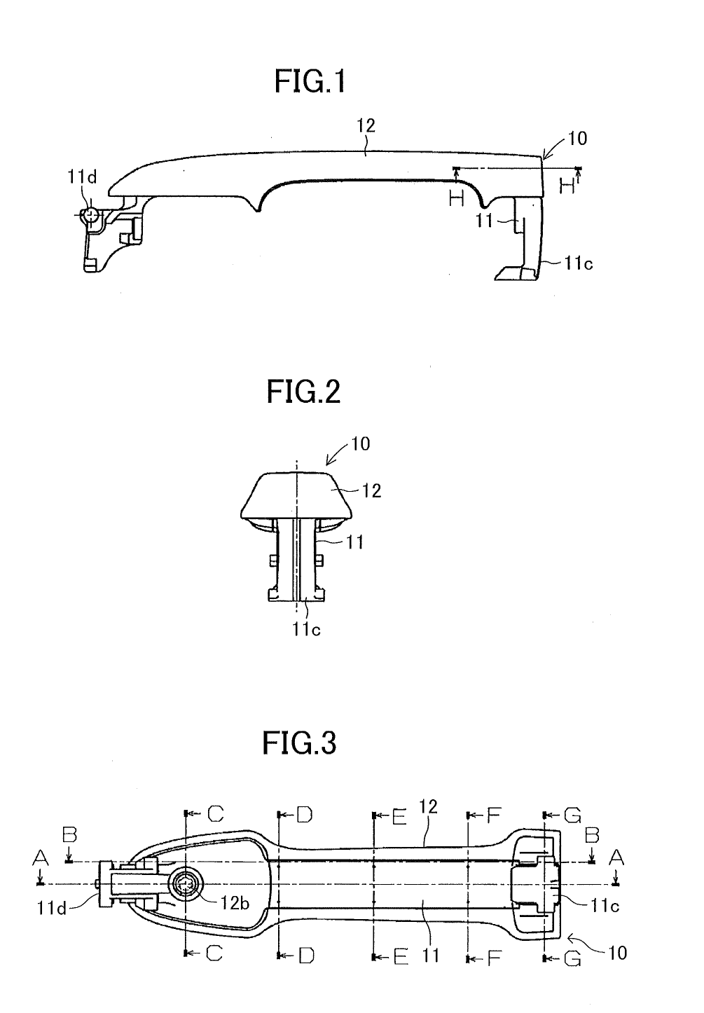

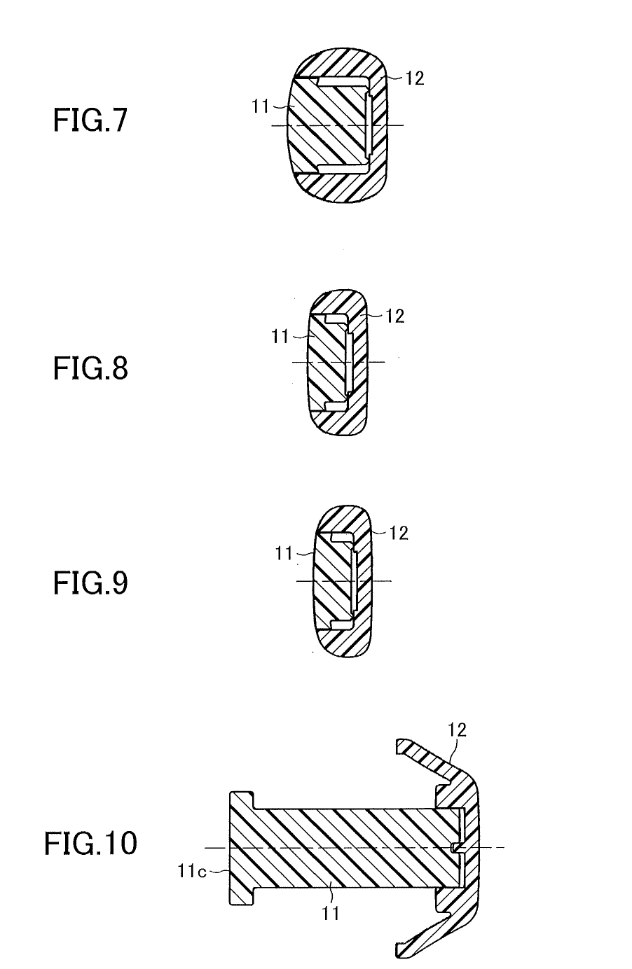

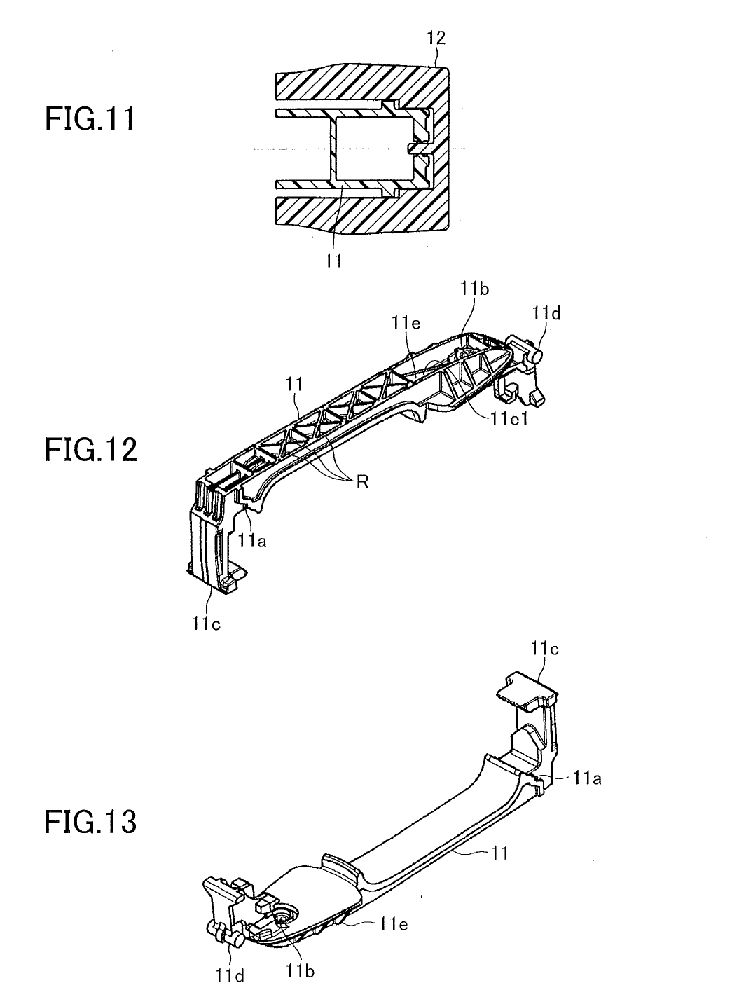

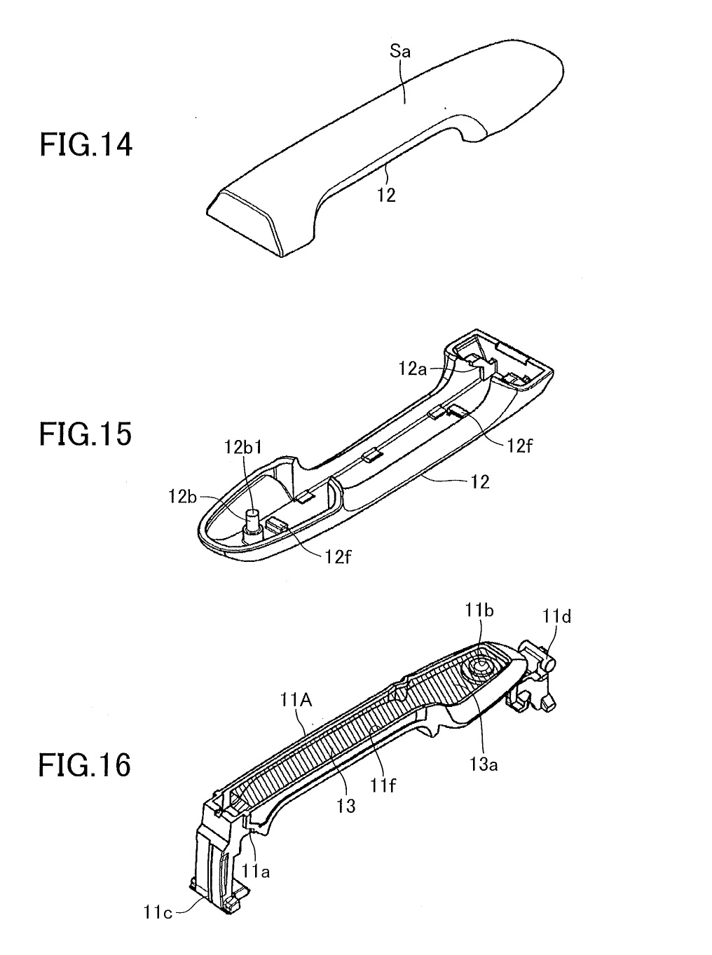

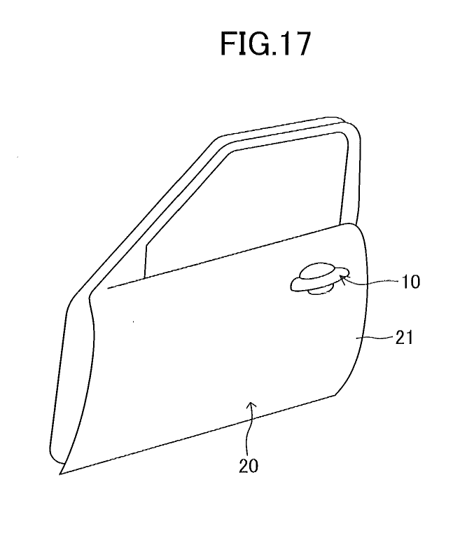

Now, embodiments of the present invention are described below with reference to the drawings. FIGS. 1 to 11 illustrate a door handle for a vehicle of an embodiment according to the present invention. The door handle 10 for a vehicle comprises a handle body 11 made by resin and a handle cover 12 made by resin, and, as shown in FIGS. 1 to 3, the handle body 11 and the handle cover 12 are configured to be mounted integrally outside the door 20 (cf. the side door shown in FIG. 17) of the vehicle.

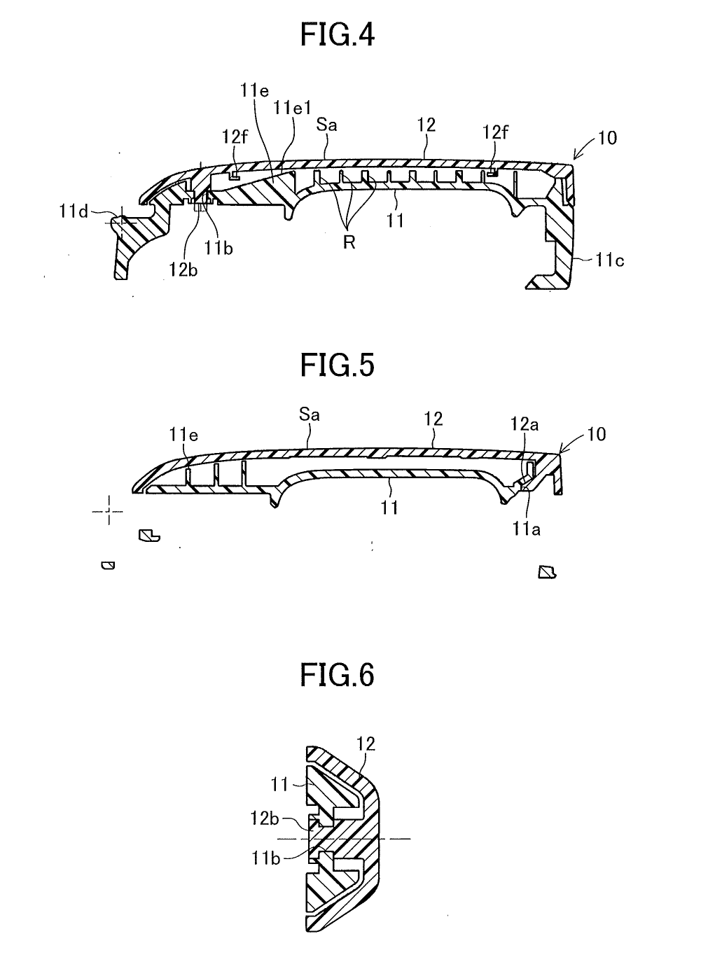

The handle body 11 is an inner member disposed on the inner side in a state of being mounted outside the door 20. As shown in FIGS. 1 to 11, 12 and 13, the handle body 11 comprises a pair of engagement protrusion 11 a on one end portion (an end portion that becomes the rear side in a state of being mounted on the door 20 of the vehicle) and comprises one pin through-hole 11b on the other end portion (an end portion that becomes the front side in a state of being mounted on the door 20 of the vehicle), and a first arm (rear arm) 11c is provided on one end thereof, and a second arm (front arm) 11d is provided on the other end thereof. The pin through-hole 11b is a stepped through hole, as shown in FIGS. 4 and 6, is configured to comprise a large diameter in the inside (the bottom side in FIG. 4, the left side in FIG. 6).

Note that, as is well known, the first arm (rear arm) 11c is configured to penetrate through the door outer panel 21 and to extend in the door 20 in a state that the door handle 10 for a vehicle is mounted outside the door 20, and is configured to work with a lever (not shown in the figures) linked with the door lock device (not shown in the figures) mounted inside the door 20. Also, as is well known, the second arm (front arm) 11d is configured to penetrate through the door outer panel 21 and to extend in the door 20 in a state that the door handle 10 for a vehicle is mounted outside the door 20, and is configured to be supported rotatably (pivotably) by a support member (not shown in the figures) fixed inside the door outer panel 21.

Further, the handle body 11 has a reinforcing rib R. As shown in FIGS. 4 and 12, the reinforcing rib R is provided to the central portion (the part that, i.e., is pressed to the vehicle outside at the time of operation of the door handle 10 for a vehicle) of the handle body 11. Also, the reinforcing rib R stands to form substantially a rectangular shape with a sidewall of the handle body 11, and to form the diagonal of the rectangular shape. Therefore, at the time of the operation of the door handle 10 for a vehicle, the central portion of the handle body 11 is hard to flex by an effect of the reinforcing rib R, and the operation feeling of the door handle 10 for a vehicle can improve.

The handle cover 12 is an outer member disposed on the outer side in a state of being mounted outside the door 20. As shown in FIGS. 1 to 11, 12 and 13, the handle cover 12 is united to an outside of the handle body 11 integrally and covers the outside, and comprises on one end portion a pair of engagement recess 12a to which the engagement protrusion 11a is connected so that the engagement protrusion 11 a can tilt, and comprises on the other end portion a stepped connection pin 12b which is inserted through the pin through-hole 11b and penetrates through the pin through-hole 11b, and a decoration (e.g., painting or plating) is provided to at least outer surface (exterior surface) Sa thereof.

Further, the handle cover 12 is united to the handle body 11 integrally by an end portion of the connection pin 12b being affixed to a large diameter portion of the pin through-hole 11b by heat caulking (welding) (the end portion (the small diameter portion) of the connection pin 12b is set in a retaining condition, in which its diameter becomes bigger than a diameter of the small diameter portion of the pin through-hole 11b) in conditions (cf. virtual line of FIG. 4) that the engagement protrusion 11a is connected to the engagement recess 12a and a small diameter portion of the connection pin 12b is inserted through the small diameter portion of the pin through-hole 11b.

As described above, according to the door handle 10 for a vehicle of this embodiment, it is not had to provide each arm to the handle cover 12 in which a decoration (e.g., painting or plating) is provided to the outer surface Sa, because the first arm 11c and the second arm 11d are provided to the handle body 11. Therefore, when decoration such as painting or plating is provided, for example, to the outer surface Sa of the handle cover 12, it is not necessary to mask an unnecessary part (each arm) of the decoration to prevent for attaching that painting or plating to the unnecessary part uselessly.

Further, according to the door handle 10 for a vehicle of this embodiment, the handle body 11 is united to the handle cover 12 integrally by the connection pin 12b being affixed to the pin through-hole 11 b by heat caulking (welding) in conditions (the state that the handle body 11 and the handle cover 12 are combined and joined each other) that a pair of engagement protrusion 11a provided to the handle body 11 is connected to a pair of engagement recess 12a provided to the handle cover 12, and the connection pin 12b provided to the handle cover 12 is inserted through the pin through-hole 11b provided to the handle body 11. Therefore, in this embodiment, the fasteners (parts which are different from the handle body 11 and the handle cover 12) such as screws and welding nuts are unnecessary to join the handle body 11 to the handle cover 12 integrally.

Further, according to the door handle 10 for a vehicle of this embodiment, the pin through-hole 11b provided to the handle body 11 is formed in a long aperture shape (an even oval configuration to assume a longitudinal direction of the door handle 10 for a vehicle a longer axis is possible) extending along a longitudinal direction of the door handle 10 for a vehicle. Therefore, in this embodiment, it can make the pin through-hole 11b engage the connection pin 12b smoothly when the handle body 11 and the handle cover 12 are combined and joined each other.

Further, in the door handle 10 for a vehicle of this embodiment, the handle body 11 is provided with a guide 11e. When joining the handle body 11 to the handle cover 12 in the state that the engagement protrusion 11a is connected to the engagement recess 12a (in detail, when the handle body 11 is tilted relative to the handle cover 12, and the connection pin 12b is inserted through the pin through-hole 11b, while making the engagement protrusion 11 a engage the engagement recess 12a), the connection pin 12b is configured to be guided through the pin through-hole 11 b by the guide 11e. In detail, the guide 11e is one of libs stood outside the handle body 11, and comprises a guide surface 11e1 inclining toward for the pin through-hole 11b from the central portion side of the handle body 11. The connection pin 12b is guided through the pin through-hole 11b by a distal surface 12b1 of the connection pin 12b being guided by the guide surface 11e1. Therefore, according to this embodiment, it can smoothly perform joining work (processing) for joining the handle body 11 to the handle cover 12.

Further, as shown in FIGS. 4 and 15, according to the door handle 10 for a vehicle of this embodiment, a pair of locking parts 12f for stopping a tool (not shown in the figures) for decoration is formed integrally inside of the handle cover 12. According to this embodiment, it can easily (smoothly) perform work (processing) for providing a decoration to at least the outer surface Sa of the handle cover 12.

In the embodiment, the door handle 10 for a vehicle comprising the handle body 11 made by resin and the handle cover 12 made by resin is described. However, as shown in FIG. 16, it is possible to use both a handle body 11A made by resin and electronic parts 13 (the part which a slanted line is referred to) in substitution for the handle body 11 made by resin. The constitution of the handle body 11A is substantially the same as the constitution of the handle body 11 except that its outside portion comprises a storing recess 11f for storing electronic parts 13 in substitution for the lib (the guide 11e), and the handle body 11A comprises a pair of engagement protrusion 11a, one pin through-hole 11b, the first arm (rear arm) 11c, the second arm (front arm) 11d, and the like.

Electronic parts 13 is, for example, function parts being equal to the electronic parts disclosed in JP 4543722 B of Patent Literature 1 mentioned above and JP 4600323 B, and is assembled to the storing recess 11f of the handle body 11A before the handle body 11A is united to the handle cover 12 integrally. The function being equal to the guide 11e of the described above embodiment is kept to electronic parts 13. In detail, the connection pin 12b is guided through the pin through-hole 11b by the distal surface 12b1 of the connection pin 12b being guided by an exterior surface 13a of electronic parts 13.

Further, in the embodiment, it is the explanation that the door handle 10 for a vehicle is mounted on the side door (front side door, rear side door) of the vehicle. However, in the case of mounting the door handle for a vehicle to the back door of the vehicle, the door handle for a vehicle of the present invention can be applied similarly or changes appropriately and can apply. Further, in the embodiment, it is the explanation that the end portion of the connection pin 12b is affixed to the large diameter portion of the pin through-hole 11b by heat caulking (welding). However, the end portion of the connection pin 12b can be affixed thermally to the large diameter portion of the pin through-hole 11b by vibration welding, and the like.

1. A door handle for a vehicle, comprising:
a handle body made by resin, which has on one end side thereof an engagement protrusion and a first arm, and on the other end side thereof a pin through-hole and a second arm,
a handle cover made by resin, which has on one end side thereof an engagement recess to which the engagement protrusion is connected so that the engagement protrusion can tilt, and has on the other end side thereof a connection pin inserted through the pin through-hole and penetrating through the pin through-hole, and a decoration is provided to a least outer surface of the handle cover, and the handle cover is united to the outside of the handle body integrally and covers outside the handle body by the connection pin being welded and affixed to the pin through-hole in conditions that the engagement protrusion is connected to the engagement recess and the connection pin is inserted through the pin-through hold, wherein the handle body and the handle cover are mounted integrally outside the door of the vehicle.

2. A door handle for a vehicle according to claim 1,
wherein the pin through-hole is oval configuration to assume the long distance direction of the door handle for a vehicle a longer axis, or is a long aperture shape to extend along a longitudinal direction of the door handle for a vehicle.

3. A door handle for a vehicle according to claim 1,
wherein the handle body is provided with a guide which can guide the connection pin of the handle cover through the pin through-hole of the handle body when the handle body is joined to the handle cover.

4. A door handle for a vehicle according to claim 1,
wherein a locking part for stopping a tool for decoration is formed integrally inside of the handle cover.
